(19) United States
(12) Patent Application Publication
(10) Pub. No.: US 2013/0208459 A1
(43) Pub. Date: Aug. 15, 2013

(54) LAMP ASSEMBLY

(71) Applicants: Bryan L. Ackerman, Freeland, MI (US); Sunbo Hwang, Midland, MI (US)

(72) Inventors: Bryan L. Ackerman, Freeland, MI (US); Sunbo Hwang, Midland, MI (US)

(21) Appl. No.: 13/715,366

(22) Filed: Dec. 14, 2012

Related U.S. Application Data
(60) Provisional application No. 61/596,880, filed on Feb. 9, 2012.

(51) Int. Cl. F21V 29/02

(52) U.S. Cl. CPC F21V 29/02
USPC 362/218

(57) ABSTRACT

An example includes an apparatus for circulating a gas, the apparatus including a lamp including a filament, the lamp being substantially linear and elongate. A translucent housing can be disposed around the lamp and define a space between the lamp and the translucent housing. A manifold can be coupled to the translucent housing and define a manifold interior configured to be coupled to a pressure source, the manifold interior being in fluid communication with the space between the lamp and the translucent housing. Furthermore, a seal can be disposed between the translucent housing and the manifold that is configured to resist flow of the gas at a selected pressure. The lamp can be slideably removable through an assembly including the translucent housing sealed to the manifold.

### CROSS-REFERENCE TO RELATED APPLICATION

This application claims the benefit of. U.S. Provisional Application No. 61/596,880, filed Feb. 9, 2012, which is herein incorporated by reference.

### FIELD OF DISCLOSURE

Embodiments of the present disclosure are directed toward, but not by way of limitation, lamp assemblies; more specifically, embodiments are directed toward infrared lamp assemblies for drying.

### BACKGROUND

Some processes, such as paint drying, can benefit from exposure to a lamp, such as an infrared (“IR”) lamp. Such exposure can decrease drying time, and can produce other benefits, such as increasing the toughness of a coating such as paint. Such lamps, however, can become very hot in use. In some instances, it can be undesirable to expose the atmosphere around the drying work piece to hot equipment.

For at least this reason, attempts have been made to control the temperature of lamps. For example, U.S. Pat. No. 3,204,085 describes an explosion-resistant heating device with filaments disposed in quartz tubes. In another example, U.S. Pat. No. 4,968,871 provides an IR heater with a ventilated framework.

### OVERVIEW

This overview is intended to provide an overview of subject matter of the present patent application. It is not intended to provide an exclusive or exhaustive explanation of the invention. The detailed description is included to provide further information about the present patent application.

One or more embodiments of the present disclosure include a lamp assembly that can direct a gas over a lamp that is substantially linear. Such lamp assembly's of the present disclosure are easy to service, provide an acceptable level of cooling, and sufficiently insulate nearby atmosphere, such as atmosphere in a dryer, from lamp generated heat. For one or more embodiments, an apparatus for circulating a gas includes a substantially linear and elongate lamp, such as a lamp having a filament. The lamp can be, for example, an IR lamp. Surrounding the lamp can be a translucent (e.g. a transparent) housing, creating a space between the lamp and the translucent housing. A gas-carrying manifold can be coupled to the translucent housing to circulate gas through the space. The manifold defines an interior configured to be coupled to a pressure source such as compressed air. The manifold interior can be in fluid communication with the space between the lamp and the translucent housing.

The translucent housing can be sealed to the manifold. In some cases, an o-ring can be used to seal the housing to the manifold, such as to allow different rates of thermal expansion for the translucent housing and the manifold by allowing one or both to slide against the seal. In various embodiments, the seal can be sufficient to maintain a desired pressure level in the manifold. To improve serviceability, the lamp can be slideably removable. The lamp can be slid out of the translucent housing, through the manifold, without upsetting the seal between the two.

For one or more embodiments, a system and related method is provided for creating a gas curtain around a translucent housing and onto a work piece, wherein the gas curtain displaces atmosphere that would otherwise flow near a lamp or a housing containing a lamp. This gas curtain can keep atmospheric gasses away from the lamp in use, in effect shielding the lamp from those gasses.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments of the invention.

FIG. 1A shows a side view of a lamp assembly and a work piece according to one or more embodiments of the present disclosure.

FIG. 1B shows a right side view of the lamp assembly of FIG. 1A according to one or more embodiments of the present disclosure.

FIG. 2A shows a perspective view of a lamp slideable out of a lens box according to one or more embodiments of the present disclosure.

FIG. 2B is a close-up view of FIG. 2A, showing curved gas flows in broken line, according to one or more embodiments of the present disclosure.

FIG. 3A is an elevated perspective view of a hood, showing sectioned and exploded, according to one or more embodiments of the present disclosure.

FIG. 3B is an elevated perspective view of a hood, showing sectioned and exploded, according to one or more embodiments of the present disclosure.

FIG. 3C is a bottom view of an exploded hood according to one or more embodiments of the present disclosure.

FIG. 3D is a cross-sectioned perspective view taken along the line 3D-3D in FIG. 3C.

FIG. 3E is a right side view of the hood taken along line 3D-3D in FIG. 3C.

FIG. 3F is a perspective view showing a lamp and a translucent housing, according to one or more embodiments of the present disclosure.

FIG. 4A is a bottom view of a lamp assembly according to one or more embodiments of the present disclosure.

FIG. 4B is a section view taken at line 4B-4B in FIG. 4A.

FIG. 4C is a section view taken at line 4C-4C in FIG. 4B.

FIG. 4D is a section view taken at line 4D-4D in FIG. 4C.

FIG. 5 is a cross-section of a flow directing plenum, showing flow stream-lines, according to one or more embodiments of the present disclosure

FIG. 6A shows a flow diagram of an example drying system 600 according to one or more embodiments of the present disclosure.

FIG. 6B shows a portion of FIG. 6A according to one or more embodiments of the present disclosure.

FIG. 7 shows a method of cooling a work piece with a lamp assembly, according to one or more embodiments of the present disclosure.

FIG. 8 is a plot showing infrared intensity according to one or more embodiments of the present disclosure.

### DETAILED DESCRIPTION

The present disclosure provides various embodiments of systems, devices, and methods for a lamp assembly. The various embodiments of the present disclosure provide lamp assemblies that are easy to service such that down time associated with changing out burnt bulbs can be minimized, that provide an acceptable level of cooling, and that can sufficiently insulate nearby atmosphere, such as atmosphere in a dryer, from lamp generated heat. Additionally, the various embodiments of the present disclosure can provide a more cost efficient lamp assembly by minimizing leaking

As discussed herein, the temperature of the lamp can increase while in use and expose the atmosphere to the heat generated by the lamp. In some instances, it can be undesirable to expose the atmosphere to the heat generated by the lamps. Previous attempts to control the temperature of lamps included devices that expose the IR lamp directly to atmosphere below the lamp, which can unfavorably heat the atmosphere. In addition, previous attempts to control the temperature of lamps can include devices that do not provide easy lamp replacement, where replacing the lamp can damage a seal.

The present disclosure improves upon the previous attempts by providing embodiments of a lamp assembly that provide easy lamp replacement, provide control of the temperature of lamps, and insulates the nearby atmosphere from lamp generated heat. For one or more embodiments, an emitter, such as a radiation emitter (e.g. a lamp), can be disposed inside a separate tube that surrounds the lamp (e.g., a silica-based tube such as a quartz tube) creating a space that impedes thermal convection and conduction between the lamp and surrounding atmosphere. The space can also be used to convection cool the lamp, such as by flowing cooling gas through the space.

For one or more embodiments, a lamp manifold is configured to commute such gas in a sealed manner, while allowing for the easy removal of spent lamps with less seal damage. Thus, the lamp assembly of the present disclosure can be easier to service and reduces the risk of damaging seals. This design also consumes less energy, as it leaks less cooling gas, making it less expensive to operate.

For one or more embodiments, an air curtain is provided that drapes away from the lamp (or a tube surrounding the lamp), which can push atmosphere away from the lamp. The air curtain can thereby displace atmosphere, which should not be heated with gas that is more inert. As a result, instances of unwanted gas heating can be reduced or eliminated, increasing safety. These “curtain” embodiments can be used to separate heated surfaces from atmosphere in a drier. The foregoing embodiments represent only some of the benefits the present disclosure can provide to users of lamps such as IR lamps.

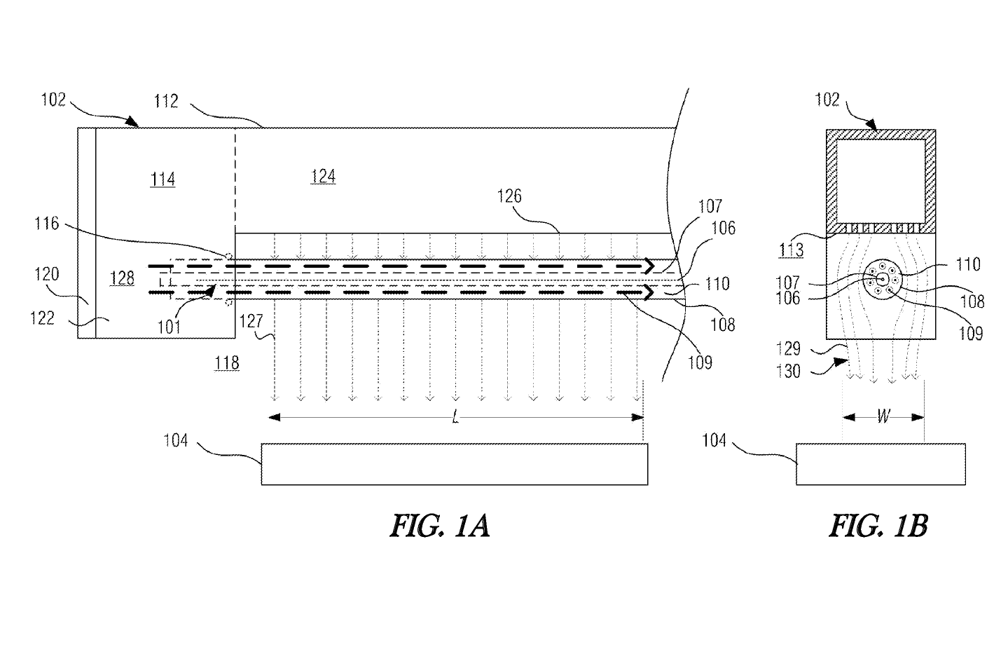

FIG. 1A shows a side view of a lamp assembly 102 and a work piece 104, according to one or more embodiments of the present disclosure. FIG. 1B shows a right side view of the lamp assembly of FIG. 1A, in cross section taken along the break line of FIG. 1A, according to one or more embodiments of the present disclosure. Aspects of the lamp assembly are for circulating a gas, such as for cooling the lamp. Certain aspects direct gas away from a specific area (e.g., the area between the work piece and the lamp).

For one or more embodiments, the lamp assembly 102 can include a lamp 101 including a filament 106. The lamp 101 can be substantially linear and elongate, extending along a length L, although other shapes, including curvilinear shapes, can be used. For one or more embodiments, lamp 101 includes a filament housing. The filament housing can be a bulb such as a glass bulb 107. For one or more embodiments, the glass bulb 107 is cylinder shaped and envelopes the filament 106. The filament housing can comprise a tube formed of silica, such as a glass tube or quartz tube. The present disclosure is not limited to quartz, and other suitable materials such as silica-based materials can be used.

For one or more embodiments, the filament housing (e.g., glass bulb 107) is adapted to transmit short wave or near infrared for the range from 780 nanometers (nm) to 1400 nm. For one or more embodiments, the filament housing is adapted to transmit medium infrared for the range between 1400 nm and 3000 nm. For one or more embodiments, the filament housing is adapted to transmit far infrared or dark emitters for everything above 3000 nm. Some embodiments use quartz adapted to transmit around 780 nm, but the present disclosure is not so limited. For one or more embodiments, the lamp may not include a filament housing (e.g., glass bulb 107). That is, the lamp is comprised of a bare filament 106 with no filament housing.

For one or more embodiments, the removable filaments 106 are disposed in the translucent housing 108, and can be replaced without removing the translucent housing 108, such as by sliding them axially along the length L. For the one or more embodiments where the filament 106 is disposed in a filament housing such as glass bulb 107, the filament 106 and the glass bulb 107 can also be removed without removing the translucent housing 108. Leaving the translucent housing 108 in place helps preserve the quality of the seal (e.g. seal 116) between an interior of the translucent housing 108 and other components, such as the manifold 112.

With a translucent housing 108 disposed around the lamp 101, a space 110 is defined between the lamp 101 and the translucent housing 108. For one or more embodiments, the space 110 may be defined between the filament housing (e.g., glass bulb 107) and the translucent housing 108. A gas, such as a coolant, can flow through the space 110, as illustrated by stream-lines 109. The translucent housing 108 can be cylindrical, defining a cylindrical interior sized to receive the lamp 101. For one or more embodiments, a filament housing (e.g., the glass bulb 107) is cylinder shaped and is enveloped by a cylinder shaped translucent housing 108. For one or more embodiments, the space 110 can be defined between a translucent housing 108 and a filament 106, with no other housing disposed between the two.

For one or more embodiments, the translucent housing 108 can be formed of transparent glass, although other suitable materials can be used, such as other transparent or translucent materials. For one or more embodiments, the glass can be formed of quartz. For one or more embodiments, the glass can be formed form other suitable materials such as silica-based materials. For some embodiments, the translucent housing 108 is transparent to only some wavelengths, such as infrared wavelengths. For one or more embodiments, the translucent housing 108 is capable of transferring at least wavelengths selected to perform a certain function (e g. heating of work surface to a desired temperature). For one or more embodiments, the translucent housing 108 can be adapted to transmit short wave or near infrared for the range from 780 nm to 1400 nm. For one or more embodiments, the translucent housing 108 can be adapted to transmit medium infrared for the range between 1400 nm and 3000 nm. For one or more embodiments, the translucent housing 108 can be adapted to transmit far infrared or dark emitters for everything above 3000 nm. For one embodiment, the translucent housing 108 can be quartz adapted to transmit around 780 nm, but the present disclosure is not so limited.

As illustrated in FIG. 1A, a plenum or manifold 112 can be coupled to the translucent housing 108. For one or more embodiments, the manifold 112 defines and separates a manifold interior 114 and a manifold exterior 118. For one or more embodiments, the manifold 112 can be configured to be coupled to a pressure source, such as a conduit filled with compressed air or some other gas or combination of gasses. The manifold interior 114 can be in fluid communication with the space 110 between the lamp 101 and the translucent housing 108. A hood or some other exhaust apparatus or drain can optionally draw air from the manifold exterior 118.

The lamp assembly 102 can include a seal 116 disposed between the translucent housing 108 and the manifold 112. The seal 116 can be disposed on one or both sides of a translucent housing 108. For one or more embodiments, the seal 116 can be a self-energizing seal. The seal 116 can also be a standard seal, such as an o-ring. Other seals are possible. The seal 116 is configured to resist the flow of the gas at a selected pressure, such as from the interior 114 of the manifold 112 to atmosphere near the work piece 104.

For one or more embodiments, the translucent housing 108 can have a different coefficient of thermal expansion than does the manifold 112. The seal 116, in some embodiments, can allow for the translucent housing 108 to expand along length L at a different rate of thermal expansion than the manifold 112. The seal 116 can allow the translucent housing 108 to expand into the manifold 112 without breaking the seal 116 against the flow of gas from the interior 114 to the exterior 118. Such seal configurations can provide benefits over designs where a plate of glass is used to seal a filament inside a box, with the non-glass portions of the box expanding at a different rate than the glass portions of the box thereby risking damage to the large sealing surface between the glass and the non-glass portions. Embodiments of the present disclosure can provide a smaller sealing area than designs including a seal that extends along length L.

For one or more embodiments, the lamp 101 can be slideably removable from the lamp assembly 102. For example, the lamp 101 can be removed by uncoupling the service plate 120 from an end portion 122 of the manifold 112. The service plate 120 can be attached to the end portion 122 with any suitable fastening means, such as cap screws and the like. The service plate 120 can be sealed to the end portion 122, such as with an o-ring, a gasket, sealant, or combinations thereof

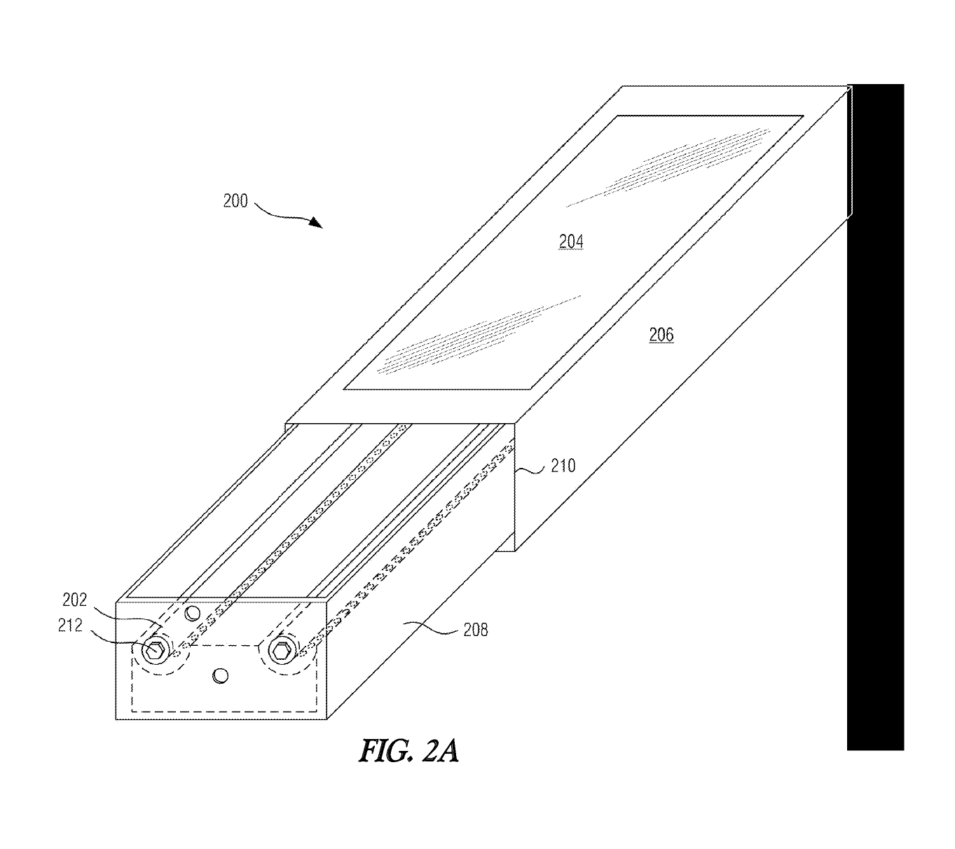

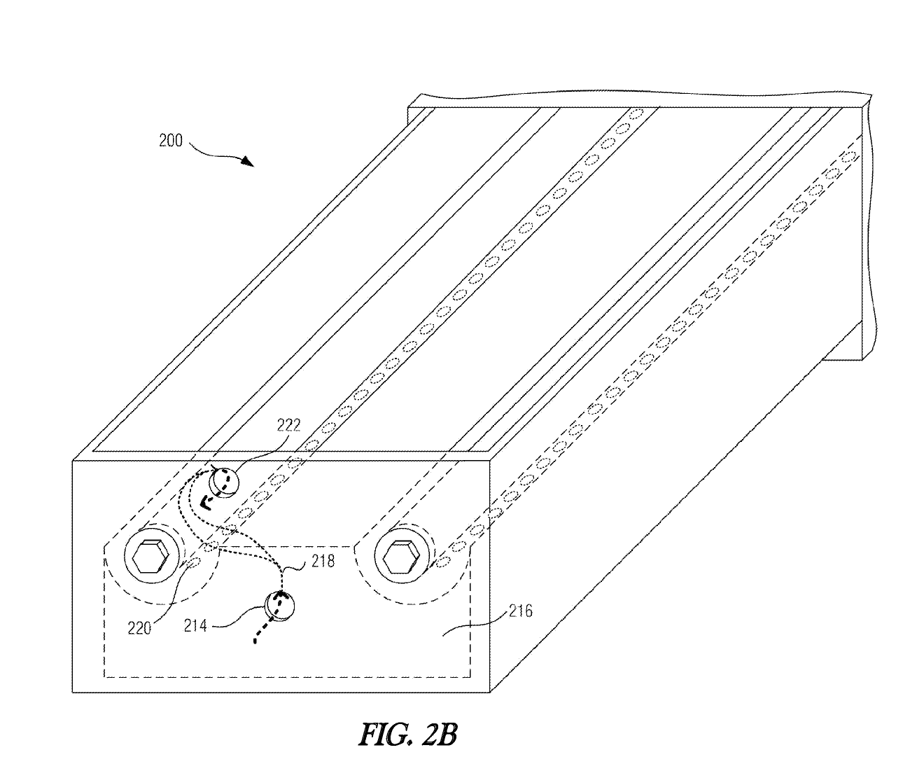

Upon removal of the service plate 120, the lamp 101 can be slid through the translucent housing 108 and out of the manifold 112. The lamp 101 can be extracted from both the translucent housing 108 and the manifold 112 at once, while leaving the seal 116 in place. This type of design can provide benefits over configurations having lamps disposed in a box with a glass window, wherein removing a lamp requires removing glass from the box (an example of such a glass pane is illustrated as 204 in FIG. 2A). Removing the glass from the box can damage or even destroy the seal, making servicing the lamp difficult. Some embodiments can also include service plugs disposed in the manifold 112, rather than, or in addition to, service plates 120.

For one or more embodiments, the manifold 112 can include a distribution portion 124 that extends alongside the translucent housing 108. The distribution portion 124 of the manifold 112 can define at least one curtain aperture 126. The at least one curtain aperture 126 can direct air from inside the distribution portion 124 of the manifold 112 to the surrounding atmosphere near the work piece 104, along stream-lines 127. For various embodiments, the curtain aperture 126 can be directed at the translucent housing 108, or at the lamp 101 in embodiments where a translucent housing 108 is not used.

For one or more embodiments, the distribution portion 124 of the manifold 112 can be sealed or partitioned from the portion of the manifold 128 in fluid communication with the space 110 between the lamp 101 and the translucent housing 108. A seal or partition can be cast or machined into the manifold, or created with a removable portion such as a dividing plate. Numerous other sealing or partitioning means are also possible, including plugs, valves and the like.

For some embodiments, the distribution portion 124 can include ambient air that has been treated, such as scrubbed or otherwise processed air, while the portion of the manifold 128 in fluid communication with the space 110 between the lamp 101 and the translucent housing 108 can be supplied with gas from another source, such as an air compressor. For one or more embodiments, the gas supplied to the distribution portion 124 and the gas supplied to the portion of the manifold 128 in fluid communication with the space 100 between the lamp 101 and the translucent housing 108 can be from the same source. Air supplied to one or both portions of the manifold 112 can be chilled prior to being introduced.

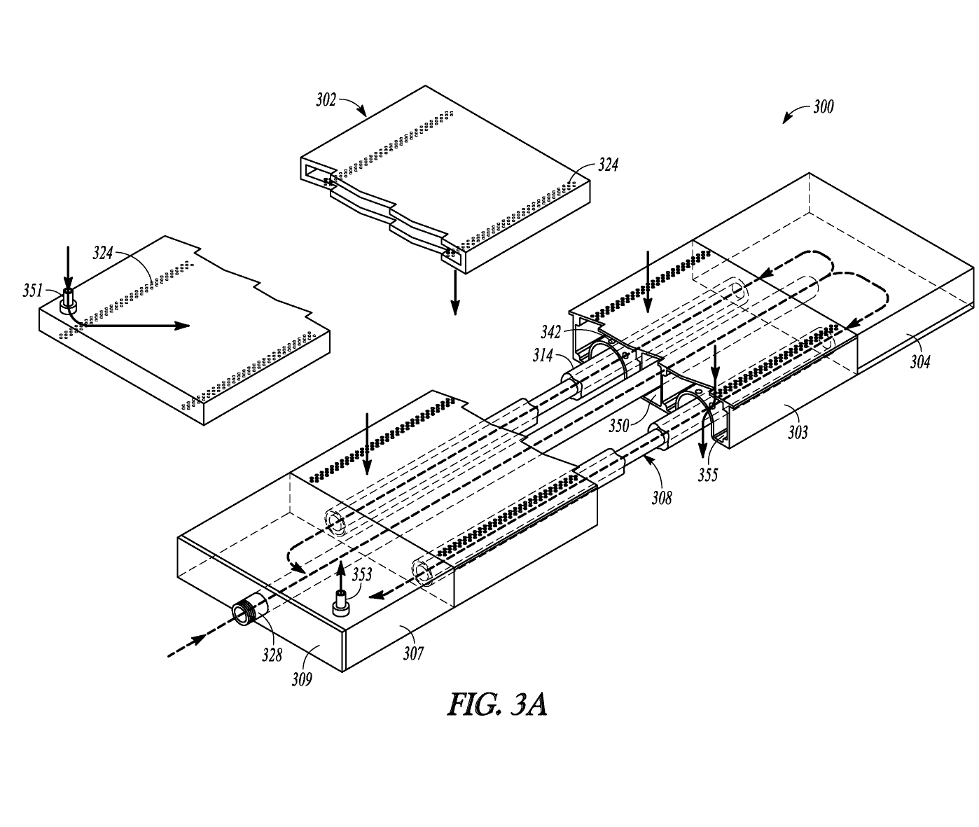

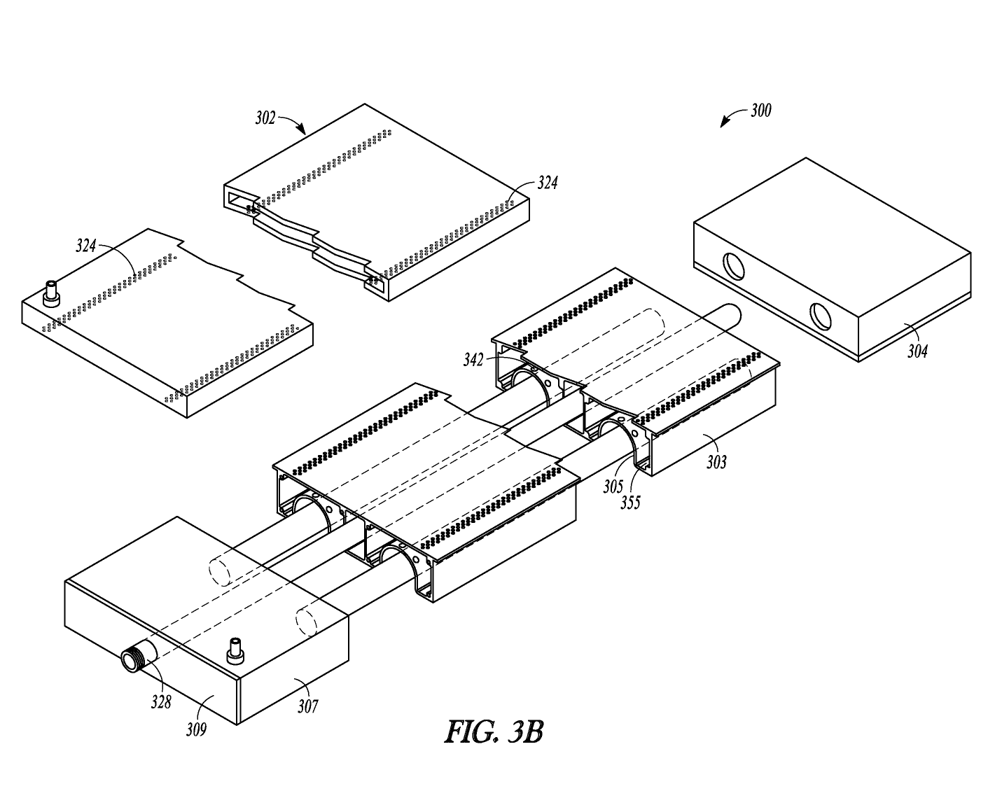

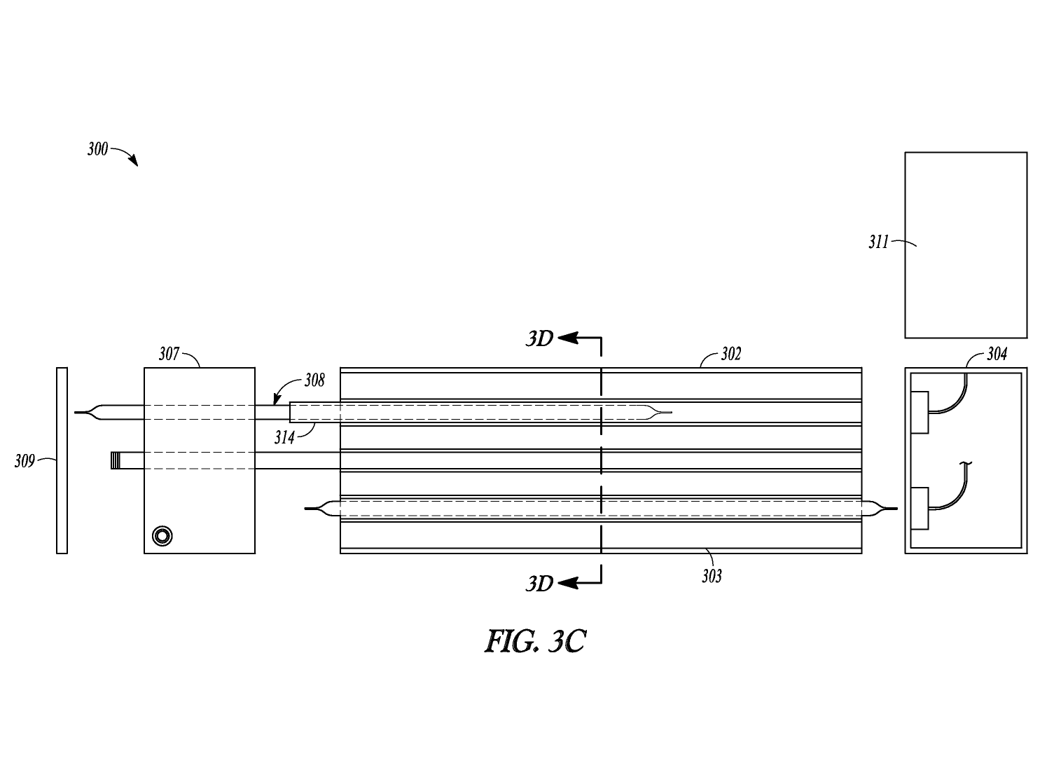

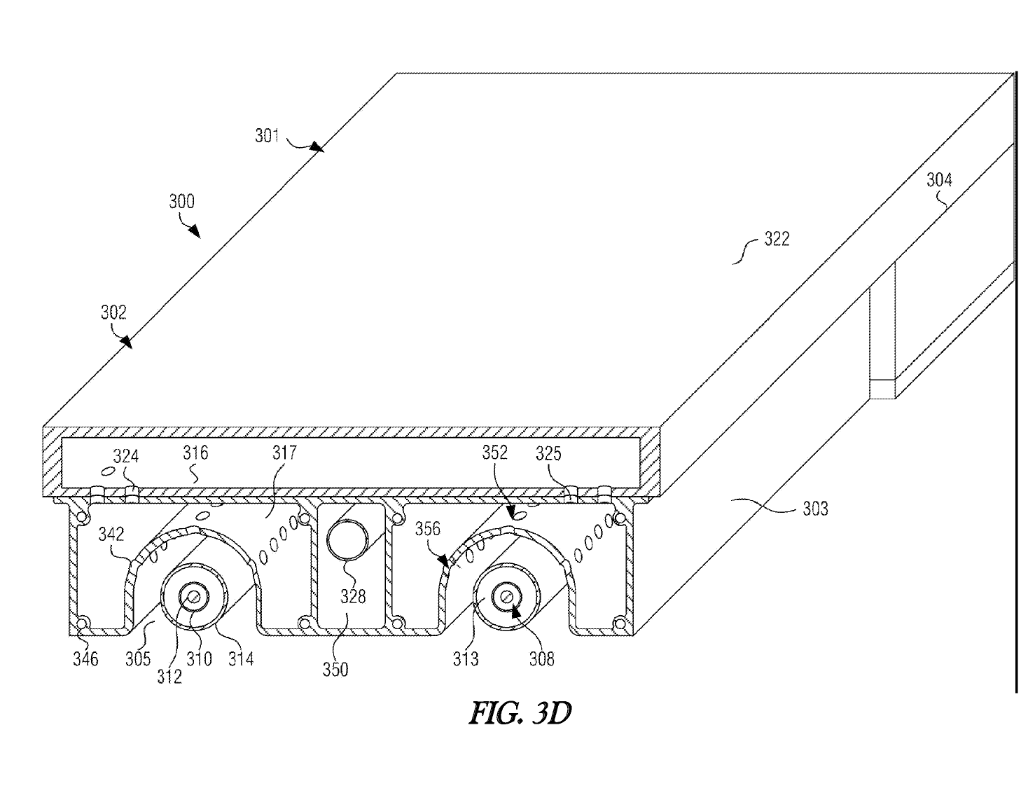

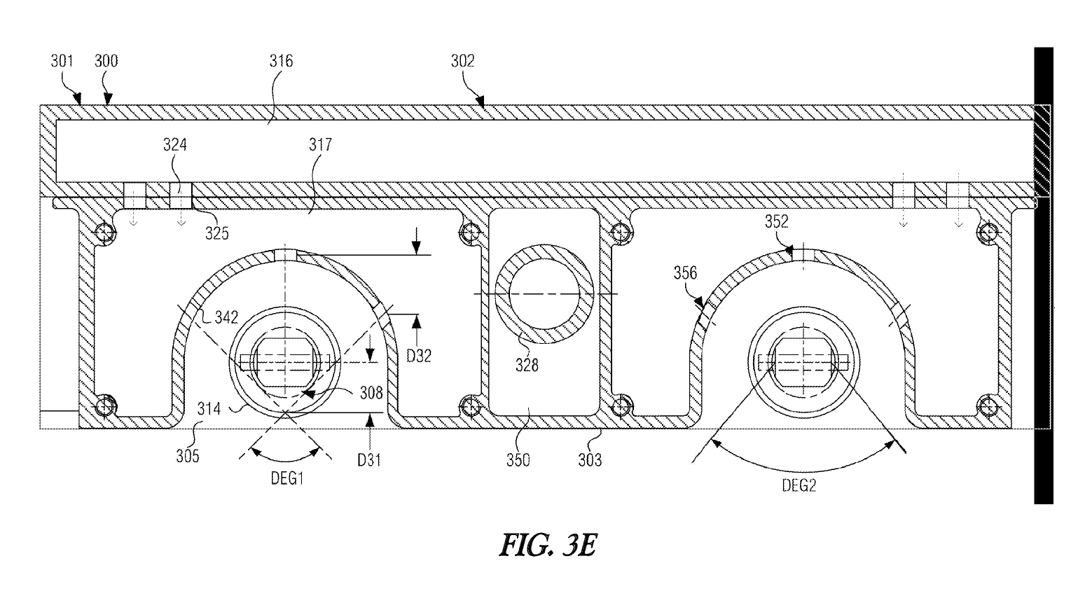

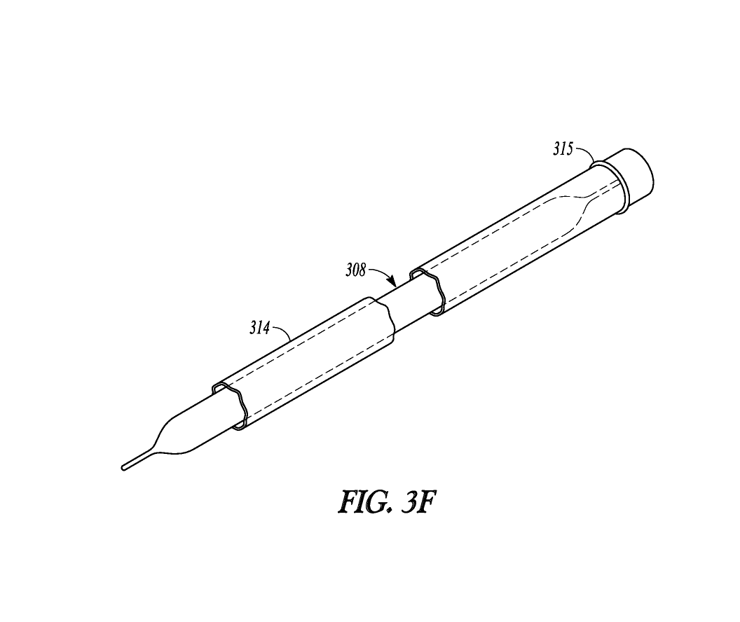

As illustrated in FIG. 1A, the at least one curtain aperture 126 can comprise a plurality of curtain apertures 126 periodically spaced along a length L of the distribution portion 124 of the manifold 112. The at least one curtain aperture 126 can be oriented to shape a flow of the gas into a sheet shaped gas curtain 130 that drapes away from the translucent housing 108 (as shown in FIG. 1B along stream-lines 129). The curtain 130 can be of a width W that can be selected to displace atmosphere proximal the work piece 104 from the translucent housing 108, or the lamp 101 in embodiments that do not include a translucent housing 108. As discussed herein, a flow distribution plenum (e.g., the flow distribution plenum 303 illustrated in FIG. 3A) can be coupled to the distribution portion 124 of the manifold 112, to further shape stream-lines 129 around the translucent housing 108. It should be noted that gas of the curtain 130 can be polarized with respect to the work piece 104, such as to attract the gas to the work piece. For one or more embodiments, the gas curtain 130 is cathodic, and the work piece 104 is anodic. In another embodiment, gas curtain 139 and the work piece 104 can be configured with opposite polarities. For some embodiments, the manifold 112 includes one or more electrodes to ionize the gas curtain 130.

FIG. 2A is a perspective view of an alternate embodiment of a lamp assembly 200 including a lamp 202 slideable out of a lamp box 206, according to one or more embodiments of the present disclosure. The illustrated lamp assembly 200 provides an improved method of replacing the lamp 202 without removing a glass window 204 of the lamp box 206. Such removal can damage or destroy a seal between the glass window 204 and the remainder of the lamp box 206. For one or more embodiments, the lamp box 206 can include a removable drawer 208 configured to hold the lamp 202. The drawer 208 can be configured to slide out of the lamp box 206, thereby exposing the lamp 202 so that the lamp 202 can be removed or otherwise serviced. The drawer 208 can be either partially or completely removable. For one or more embodiments, a seal can be disposed between the drawer 208 and the box 206. For one or more embodiments, the drawer 208 can be inserted into the lamp box 206, and a service plate can be affixed over a box opening 210. For one or more embodiments, end caps 212 can also be provided in the drawer 208 to assist in the removal of the lamp 202.

FIG. 2B is a close-up view of FIG. 2A, showing curved gas flows in broken line, according to one or more embodiments of the present disclosure. Particularly, the FIG. 2B shows a cooling inlet 214 coupled to a plenum or manifold 216. Stream-lines 218 depict the path of the air entering the inlet 214, travelling through the manifold 216, through one or more curtain apertures 220 and out of the manifold 216 through one or more outlets 222. In embodiments where the window 204 (as illustrated in FIG. 2A) is not present, the outlets 222 can be blocked, and the gas can flow away from the lamp 202, or a translucent housing in which the lamp 202 is disposed, to a work piece.

FIG. 3A is an elevated perspective view of a hood, showing sectioned and exploded, according to one or more embodiments of the present disclosure. FIG. 3B is an elevated perspective view of a hood, showing sectioned and exploded, according to one or more embodiments of the present disclosure. FIG. 3C is a bottom view of an exploded hood, according to one or more embodiments of the present disclosure. FIG. 3D is a perspective cross-section view of a assembly 300 including a lamp base 301 and a flow directing plenum 303 coupled to the lamp base 301, according to one or more embodiments of the present disclosure.

As illustrated in FIG. 3D, the lamp base 301 comprises a manifold 302 that includes a distribution portion 322. The distribution portion 322 is mateable to other components, such as the flow directing plenum 303, to distribute gas into the other components (e.g., the flow directing plenum 303). For one or more embodiments, an example gas flow is into manifold inlet 351 (illustrated in FIG. 3A), through an interior void 316 of the manifold 302, out of apertures 324 and into apertures 325, through the interior void 317 of the flow directing plenum 303, and out curtain apertures 342. The distribution portion 322 of the manifold 302 can include the interior void 316 that can be pressurized to direct gas out of the outlet apertures 324. Accordingly, pressurized gas such as compressed air can enter the interior void 316, pass through the apertures 324, 325, enter a plenum interior void 317 and then exit through one or more curtain apertures 342 to an atmosphere surrounding the assembly 300. This gas creates a gas curtain to keep gas away from the translucent housing 314, among other things.

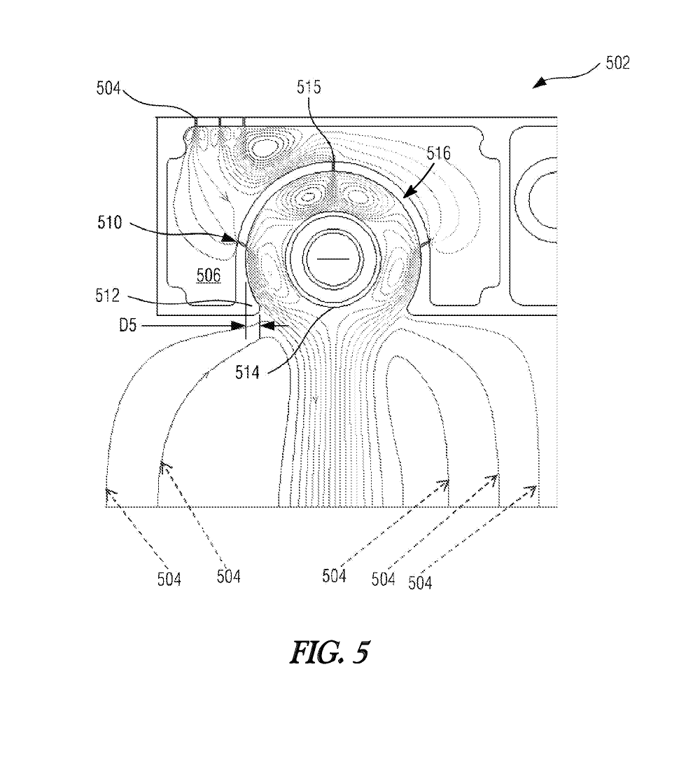

The gas curtain is useful to keep gas away from one or more lamps 308 that are mounted to the lamp base 301 and extend through reliefs 305 in the flow directing plenum 303. For one or more embodiments, a lamp 308 includes a filament and a bulb, although the bulb is optional as discussed herein. Various embodiments use a plurality of curtain apertures 342 to create the gas curtain. Various embodiments can include a plurality of curtain apertures 342 arranged in a pattern. For one or more embodiments, the plurality of curtain apertures 342 can include a plurality of columns (illustrated in FIG. 3D, among others) of curtain apertures 342 aligned along respective axes parallel to the translucent housing 314. An engineered curtain shape is referenced in FIG. 5. For one or more embodiments, the plurality of columns can include one top column 352 aligned above the translucent housing 314. For one or more embodiments, the plurality of columns can include opposing columns 356 that can be aligned on each side of the translucent housing 314. Curtain apertures of the top column 352 can be oriented to direct the gas toward a centerline of the translucent housing 314, and the curtain apertures of the opposing columns 356 of curtain apertures 342 can be oriented to direct the gas below the centerline of the translucent housing 314.

As illustrated in the embodiment of FIG. 3E, the curtain apertures 342 of the opposing columns 356 of curtain apertures 342 can include centerlines oriented at an angle of DEG1 with respect to on another. DEG1 can be at 90 degrees, but the present subject matter is not so limited. For one or more embodiments, an intersection of the centerlines of the curtain apertures 342 of the opposing columns 356 of curtain apertures 342 can be a distance D31 from the centerline of the translucent housing 314. For one or more embodiments, the distance between the top column 352 and the opposing columns 356 can be the distance D32, which is less than a distance between the centerline of the translucent housing 314 and the top column 352.

For one or more embodiments, the curtain aperture 342 can be cylindrical with a diameter of about 5.0 millimeters (mm), although curtain apertures having larger or smaller diameters can also be used. The curtain aperture 342 can be other shapes besides cylindrical, including other curvilinear shapes such as, for example, but not limited to, cubic.

An angle DEG2 corresponds to the span of IR light the lamp 308 emits. For one or more embodiments, the lamp 308 can be backed with a coating to constrain light emission to the span illustrated. For one or more embodiments, the span is selected to project IR light onto a work piece.

For one or more embodiments, the coating is to be temperature controlled. For one or more embodiments, the coating can be formed of gold. Flowing gas between the lamp 308 and the translucent housing 314 can adequately control the temperature to preserve the coating. In some instances, this contrasts the function of gas exiting the curtain apertures 342, which may provide cooling, but are especially effective at displacing gas away from the translucent housing 314.

Returning to FIG. 3A, the lamp 308 is disposed in a translucent housing 314, defining a space between the lamp 308 and the translucent housing 314. A gas, such as the gas illustrated by arrows with broken lines, can enter an inlet conduit 328, flow into a manifold 304 and into the space(s) and out the outlet 353. The gas flowing between the lamp 308 and the translucent housing 314 can, among other things, cool the lamp 308.

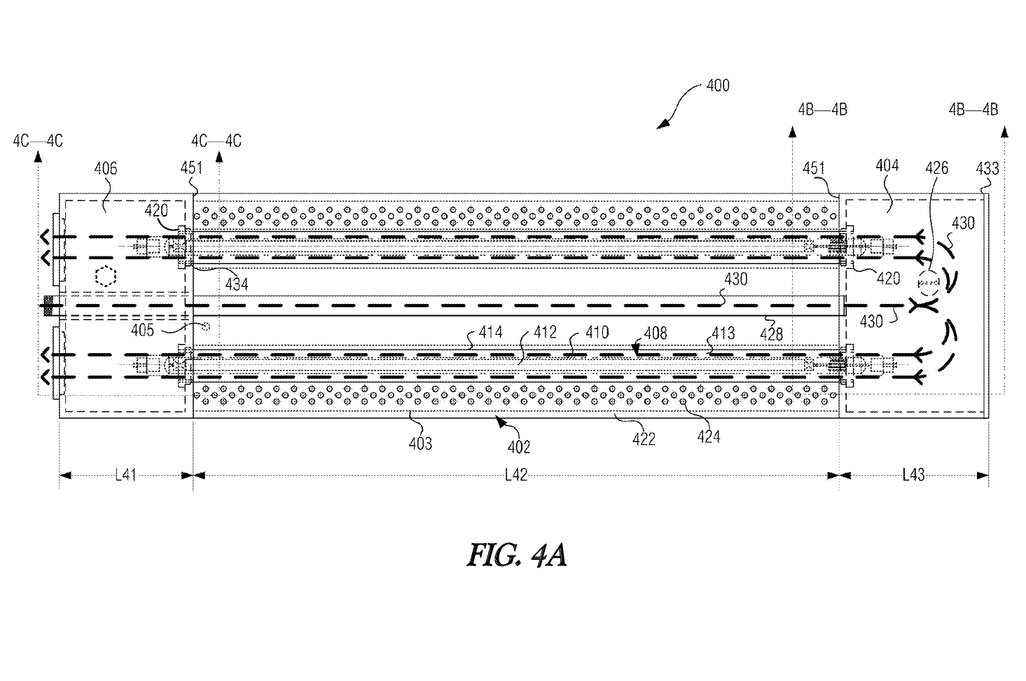

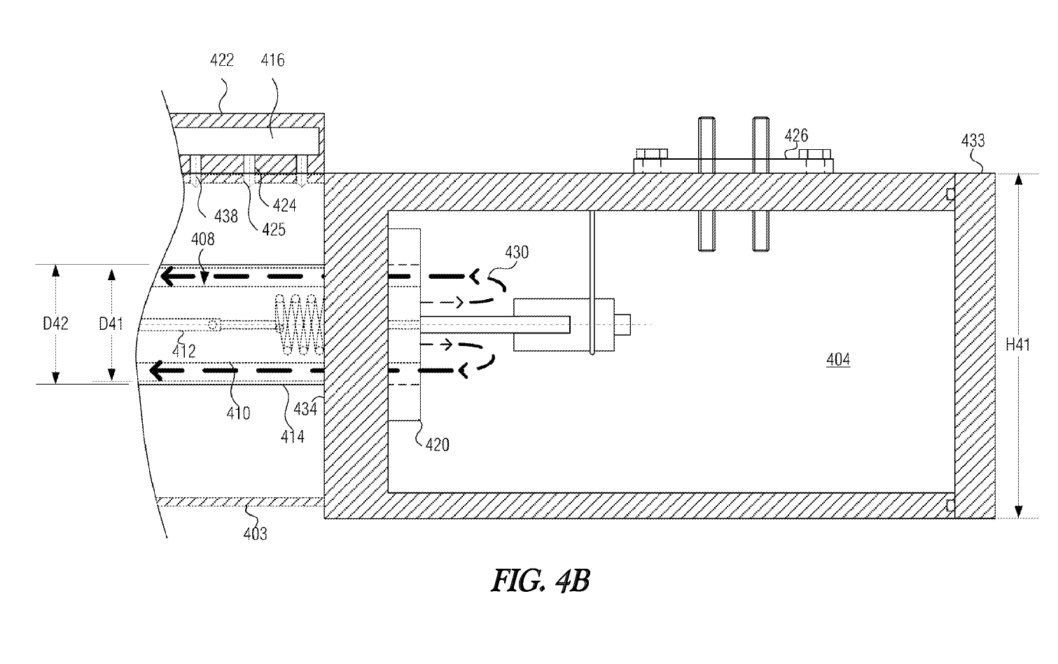

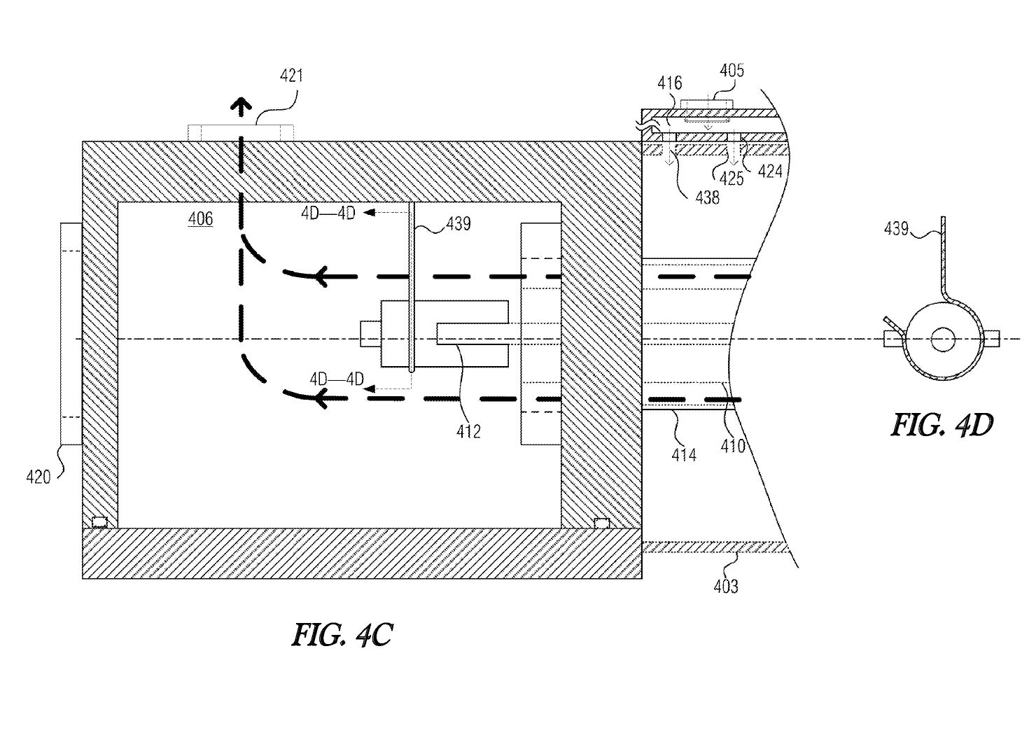

For one or more embodiments, the flow directing plenum 303 can include a tunnel 350 sized to receive an inlet conduit 328. For one or more embodiments, the tunnel 350 of the flow directing plenum 303 can be disposed between the pair of translucent housings 314 and sized to receive an inlet conduit 328. The inlet conduit 328 can extend through the tunnel 350 to couple with a manifold (e.g., the right manifold portion 404 of FIG. 4A). For one or more embodiments, the tunnel 350 opens to a side of the assembly 300 through which the lamp 308 can be slideably removable (e.g., the left manifold portion 406 of FIG. 4A), but the present subject matter is not so limited.

FIG. 3C is a bottom view of an exploded hood, according to one or more embodiments of the present disclosure. As illustrated in FIG. 3C, a service plate 309, which can be removed to allow for a lamp 308 to be slid along its axis for service. For one or more embodiments, the lamp 308 can be removed without replacing a seal between the translucent housing 314 and one or more manifolds such as manifolds 304 or 307. Another service plate 311 can also be removed for service. For example, service plate 311 can be removed to interconnect bulbs of the lamp 308 to an electrical supply, or perform other work on the assembly 300.

FIG. 3F is a perspective view showing a lamp and a translucent housing, according to one or more embodiments of the present disclosure. As illustrated in FIG. 3F, lamp 308 is disposed in translucent housing 314 and includes a seal 315. The seal 315 may provide a seal between the translucent housing 314 and one or more manifolds such as manifolds 304 or 307 (as illustrated in FIG. 3A). For one or more embodiments, the seal 315 may be an o-ring.

FIG. 4A is a bottom view of a lamp assembly 400, according to one or more embodiments of the present disclosure. The lamp assembly 400 can include a center distribution manifold 422 and two end manifolds 404, 406 on opposite sides of the center distribution manifold 422, according to an embodiment. FIG. 4B is a section view taken at line 4B 4B in FIG. 4A. FIG. 4C is a section view taken at line 4C-4C in FIG. 4A. FIG. 4D is a section view taken at line 4D-4D in FIG. 4C.

Referring to FIG. 4A, the lamp assembly 400 can include at least one lamp 408 disposed within a translucent housing 414, defining a space 413 between the lamp 408 and the translucent housing 414. As illustrated in FIG. 4A, the lamp 408 can include a bulb 410 housing a filament 412. The lamp 408 can be surrounded by the translucent housing 414, where the translucent housing 414 can be supported by the two end manifolds 404, 406. For one or more embodiments, one or more bungs 420 can be used to establish proper sealing of the lamp 408. In various embodiments, the two end manifolds (e.g., manifolds 404, 406) are in fluid communication with the distribution manifold 422 of the manifold. In other embodiments, the distribution manifold 422 is not in fluid communication with the two end manifolds 404, 406. For example, partitions 451 may be used to separate the distribution manifold 422 of the manifold from the two end manifolds 404, 406.

A plurality of outlet apertures 424 can be disposed in the distribution manifold 422 of the manifold. These outlet apertures 424 can couple with inlet apertures 425 of a flow directing plenum, such as the inlet apertures 504 of the flow directing plenum illustrated in FIG. 5. An example of such a coupling is shown in FIGS. 3A-3E. An electric feed through 426 that is suitable to provide a feed through terminal for the lamp 408 can also be used.

An inlet pipe or conduit 428 is shown in FIG. 4A (omitted from FIG. 4B and 4C for clarity), and can be open to the atmosphere on one end (e.g., the left end extending through manifold 406) and configured to flow into the manifold 404 on the right. A stream-line 430 shows gas entering through the inlet conduit 428, collecting in the right manifold 404, flowing toward the space 413 between the lamp 408 and the translucent housing 414, and exiting through a bung 421 disposed in the manifold 406 on the left. For one or more embodiments, the gas can optionally exit through a service plate, opening in the manifold or another exit.

The lamp assembly 400 optionally includes a flow directing plenum 403, including any of the plenums illustrated in FIGS. 3A-E and 5. An assembly of a lamp base and a flow directing plenum 403 can be serviced from a single side, such as by removing service plate 433, but other configurations are possible. For one or more embodiments, air flows between the lamp 408 and the translucent housing 414, entering a manifold on one side (e.g., 404) and exiting a manifold on an opposite side (e.g., 406), flowing along the length of the lamp 408.

For one or more embodiments, the spaces 413 between the lamp 408 and the translucent housing 414 are in fluid communication with an interior of the flow distribution plenum 403. Thus, one air supply can be used to pressurize both the space 413 between the lamp 408 and the translucent housing 414 and the interior of the flow distribution plenum 403. For one or more embodiments, the interior of the flow distribution plenum 403 is in fluid communication with the interior of the manifold 404 via the distribution manifold 422. For one or more embodiments, pressurized gas enters the conduit 428, flows to the manifold 404. The gas is pressurized and directed to the manifold 406 and flows through the flow distribution plenum 403 via the distribution manifold 422.

FIG. 4A show various dimensions for one or more embodiments of the present disclosure. As illustrated in FIG. 4A, dimension L41 is the length of manifold 406 (e.g., the manifold on the left), dimension L42 is the length of the distribution manifold, and dimension L43 is the length of manifold 404 (e.g., the manifold on the right). For one or more embodiments, dimension L41 can be around 153 millimeters (mm). For one or more embodiments, dimension L42 is around 740 mm. For one or more embodiments, dimension L43 is around 110 mm.

FIG. 4B is a section view taken at line 4B-4B in FIG. 4A. Referring to FIG. 4B, dimension D41 is the diameter of the interior of the translucent housing 414, and for one or more embodiments can be around 27 mm. In another embodiment, dimension D41 can be around 28.5 mm. Dimension D42 is the diameter of the exterior of the translucent housing 414. For one or more embodiments, dimension D42 can be around 30 mm. For one or more embodiments, dimension D42 can be around 32 mm. Dimension H41 is the height of the manifold (e.g., manifold 404). For one or more embodiments, dimension H41 is around 98 mm. For one or more embodiments, the height of the opposing manifold (e.g., manifold 406 illustrated in FIG. 4A) can be similar. The dimensions of various components of the lamp assembly 400 may vary between different applications.

For one or more embodiments, a seal 434 can be provided that includes an o-ring concentric with an axis along which the lamp 408 can be slideably removable. Particularly, FIG. 4B shows a bung 420 compressing the o-ring seal 434 against the manifold 404 to force the o-ring to expand radially and provide a seal between the manifold 404 and the translucent housing 414. Additionally shown are the plurality of outlet apertures 424 of the distribution manifold 422. A second set of gas streams 438 are pictured exiting an interior void 416 of the distribution manifold 422 of the manifold 402. The distribution manifold 422 can mate with a flow directing plenum 403, including any of the flow directing plenums illustrated in FIGS. 3A-E and 5, by mating one or more outlet apertures 424 to a mating one or more inlet apertures 425.

FIG. 4C is a section view taken at line 4C-4C in FIG. 4A. As illustrated in FIG. 4C, the endcap or bung 420 can be removed to slide the translucent housing 414 out of the assembly 400. Optionally, the service plate 433 (illustrated in FIG. 4B) can be removed to allow for removal of a lamp or translucent housing. A manifold bung 405 is shown providing fluid communication with the interior void 416 of the manifold 422, such as from an exterior gas source such as a compressed air source.

FIG. 4D is a section view taken at line 4D-4D in FIG. 4C. For one or more embodiments, the lamp assembly 400 can further include a hanger 439. The hanger 439 can be configured to hang the lamp 408 inside the manifold 406.

FIG. 5 is a cross-section of a flow directing plenum 502, showing flow stream-lines 504, according to one or more embodiments of the present disclosure. Particularly, the flow stream-lines 504 illustrate gas flow from the flow directing plenum 502. The flow directing plenum 502 of FIG. 5 has curtain apertures 510 of a diameter of about 3.6 mm, although curtain apertures having larger or smaller diameters can also be used. In operation, gas flows into inlet apertures 504, into a flow directing plenum interior 506, through curtain apertures 510, around the translucent housing 514 and toward a work piece. As the gas flows toward the work piece, it generally maintains a curtain shape. This curtain shape can extend along the length of the translucent housing, draping down, or at least partially down, toward a work piece. This can be particularly helpful at keeping gasses away from the translucent housing 514, such as to prevent oxidation or other chemical reactions.

Various embodiments include a gas foil or spoiler 512 disposed along the exit path of gas from the distribution curtain apertures. For one or more embodiments, the spoiler 512 extends a distance D5 toward a plane extending through the centerline of the translucent housing 514 and a top distribution curtain aperture 515. Accordingly, an opening between opposing spoilers has a width that is less than a maximum diameter of a channel 516 through which the translucent housing 514 extends.

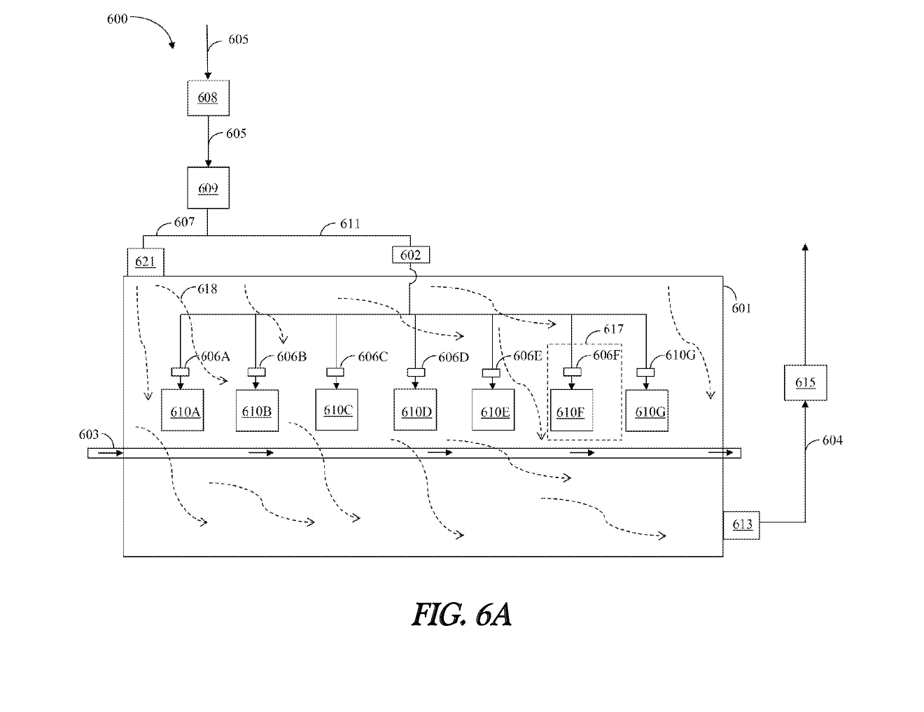

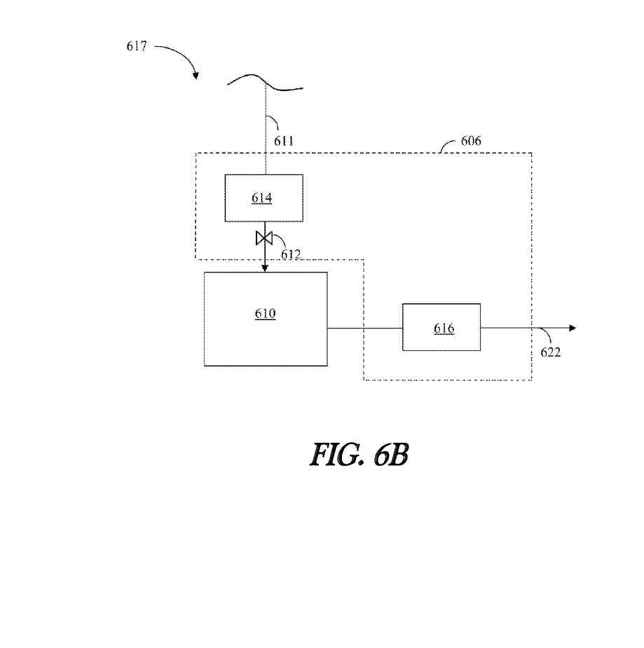

FIG. 6A shows a flow diagram of an example drying system 600. The drying system 600 includes a plurality of lamp assemblies 610A-610G (collectively referred to herein as “lamp assemblies 610” positioned in a drying chamber 601. While the example illustrated in FIG. 6A includes seven lamp assemblies 610, any number of lamp assemblies 610 may be used. The number of lamp assemblies 610 used in the system 600 can vary based on various factors, including, but not limited to, drying time of the work piece. System 600 can include a conveyer belt 603 that can move underneath the lamp assemblies 610 to carry a work piece to be dried. In some examples, more than one chamber 601 can be used. For example, a plurality of drying chambers such as six chambers 601 where each chamber 601 includes a plurality of lamp assemblies 610 may be used to dry a work piece.

In one or more embodiments, the system 600 can include a regulator 602 and each lamp assembly 610A-610G can include a monitoring system 606A-606G (collectively referred to here as “monitoring systems 606”) that can be used in conjunction with the system 600. For example, the regulator 602 may be operably coupled to the monitoring systems 606 to detect leaks within the lamp assemblies 610.

As illustrated in FIG. 6A, air can be provided to the system 600 via air stream 605. In one example, a supply fan 608 can receive the air stream 605 from, for example, an air compressor (not shown). The air stream 605 can leave the supply fan 608 and enter a steam coil 609. The steam coil 609 can be used to generate steam that can be circulated within the chamber 601 and the lamp assemblies 610. After the steam coil 609, the resulting stream can be split between a chamber air stream 607 and a lamp air stream 611. The chamber air stream 607 can enter the chamber 601 and the lamp air stream 611 can enter the lamp assemblies 610 positioned within the chamber 601. As illustrated in FIG. 6A, the air forming the lamp air stream 611 and the chamber air stream 607 are from a single source. However, in other embodiments the air forming the lamp air stream 611 and the chamber air stream 607 can be from different sources.

The chamber air stream 607 can enter a chamber inlet 621 and air 618 can be circulated throughout the chamber 601 until the air 618 exits the chamber 601 at a chamber outlet 613. For example, an exhaust fan 615 can move the air 618 out of the chamber 601. The supply fan 608 and the exhaust fan 615 operate to circulate air 618 within the chamber. Circulating air 618 throughout the chamber 601 can help prevent hot-spots within the chamber 601 and assist in maintaining control of the internal temperature of the chamber 601. For example, circulating the air can minimize the risk of forming pockets of zero air movement. Minimizing pockets of zero air movement can assist in cooling the chamber temperature and continuously pull vapors away from the lamp.

Lamp air stream 611 can enter each of the lamp assemblies 610. For example, a portion of the lamp air stream 611 can enter the lamp assemblies 610 via a manifold inlet (e.g., 324 illustrated in FIG. 3A) to provide the air into the sheet shaped gas curtain. Additionally, a portion of the lamp air stream 611 can enter the lamp assemblies via an inlet conduit (e.g., 328 illustrated in FIG. 3A) to provide air between a lamp and the translucent housing. In the embodiment illustrated in FIG. 6A, the lamp air stream 611 is employed to supply both the space between the lamp and translucent housing and for the sheet shaped gas curtain. However, in other embodiments, the air supplied between the lamp and the glass bulb and the air forming the gas curtain may be supplied by two different air suppliers.

As illustrated in FIG. 6A, the lamp air supply 611 is connected to the lamp assemblies 610 in parallel. However, the lamp assemblies 610 are electrically connected in series. As illustrated in FIG. 6A, the lamp air stream 611 can provide the air to the the space between a lamp and the translucent housing of a lamp assembly 610 and provide the air into an exterior of the translucent housing and into a sheet shaped gas curtain draping onto a work piece. For example, the lamp air supply 610 can supply the air to the space between the lamp 101 and the glass bulb 108 and the exterior of the glass bulb 108 and into the sheet shaped gas curtain 130, as illustrated in FIG. 1. Additionally, the air circulating within the space between the lamp and the translucent housing can exit the lamp assemblies 610 via an outlet (e.g., 353 illustrated in FIG. 3A), as described herein.

As illustrated in FIG. 6A, the lamp assemblies 610 can be connected to the regulator 602. For one or more embodiments, each lamp assembly 610A-610G can be coupled to a monitoring system 606. The monitoring system 606 can monitor the gas flow through the lamp assembly 610. The regulator 602 can receive data regarding the various gas streams and determine when a particular lamp assembly 610A-610G has a gas leak (e.g., because of a defective seal).

If a leak is detected, regulator 602 can send data to the monitoring system 606 that is coupled to the particular lamp assembly of the lamp assemblies 610 suspected of having a leak. The data sent to the monitoring system 606 can cause monitoring system 606 to shut down (e.g., stop) the flow of air to the particular lamp assembly 610 such that the leak can be serviced. However, stopping the flow of air to one of the lamp assemblies 610 does not affect the flow of air to the other lamp assemblies 610.

FIG. 6B shows portion 617 of FIG. 6A according to one or more embodiments of the present disclosure. For one or more embodiments, the monitoring system 606 can include a flow meter 614, a pressure meter 616, and a valve 612. The monitoring system 606 may be in communication with the lamp air stream 611 and a corresonding lamp assembly 610 (e.g., 610F). As discussed herein, the air circulated within the lamp assembly is pressurized. For examples, the air between the lamp and the translucent housing and the air around the exterior of the translucent housing are pressurized. Thus, the monitoring system 606 can collect and send data to the regulator 602 (as illustrated in FIG. 6A) to detect a leak in the pressurized streams within the lamp assembly 610.

For one or more embodiments, the monitoring system 606 may be used to detect a leak in the air circulated between the lamp and the translucent housing (e.g., the lamp 308 and the translucent housing 314, as illustrated in FIG. 3A). In that instance, the flow meter 614 can be coupled to an inlet of a lamp assembly 610 to monitor the flow of the air. For example, the inlet can be to the inlet conduit 328 (illustrated in FIG. 3A). The pressure meter 616 can be coupled to an outlet of lamp assembly 610 to monitor the pressure of the exit stream 622. For example, the outlet can be the outlet 353 (illustrated in FIG. 3A).

For one or more embodiments, the flow rate of the lamp air stream 611 is set to a desired flow rate to provide a desired pressure. If the pressure measured by the pressure meter 616 begins to decrease, it can be determined that there is a leak within the system. For example, if the pressure meter 616 of the monitoring system 606 decreases, it can be determined that there is a leak within the lamp assembly 610. For one or more embodiments, the valve 612 can be a check valve that will automatically stop the flow of air if the pressure decreases below a predetermined minimum. For one or more other embodiments, the monitoring system 606 can send pressure data to the regulator 602. If the pressure decreases below a predetermined minimum, the regulator 602 can activate valve 612. The activated valve 612 can close such that the lamp air stream 611 to the lamp assembly 610 is stopped. Other embodiments to monitor the lamp assembly for leaks are possible.

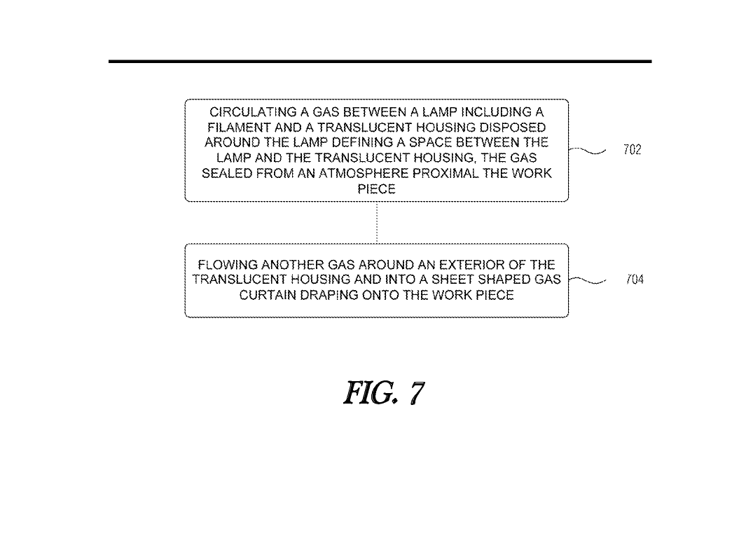

FIG. 7 shows a method 700 of cooling a work piece with a lamp assembly, according to one or more embodiments of the present disclosure. The method 700 may include cooling a lamp configured to shine on a work piece. At 702, the method 700 can include circulating a gas between a lamp having a filament and a translucent housing disposed around the lamp and defining a space between the filament and the translucent housing, wherein the gas is sealed from an atmosphere proximal the work piece. For example, lamp 101 may be cooled by circulating a gas 109 between the lamp 101 having the filament 106 and a translucent housing 108 disposed around the lamp 101 and defining a space 110, as discussed herein with respect to FIGS. 1A and 1B. For one or more embodiments, the lamp can be substantially linear and elongate. At 704, the method 700 can include flowing another gas around an exterior of the translucent housing and into a sheet shaped gas curtain draping onto the work piece. For example, another gas can be circulated around the exterior of the translucent housing 108 and into a sheet shaped gas curtain 130 draping onto the work piece 104.

The method 700 may further include providing the gas by taking air from the atmosphere proximal the work piece and scrubbing the taken air. The method 700 may further include providing the gas by collecting air from reservoir, such as a compressed air tank, that is sealed from the atmosphere proximal the work piece, and discharging the gas to another reservoir, such as a catch-can or a hood to receive the gas. For one or more embodiments, the method 700 may further include monitoring the pressure of the gas circulating between the lamp and the translucent housing. For example, the pressure of the circulated gas may be monitored by the monitoring system 606, as discussed herein with respect to FIGS. 6A and 6B. The method 700 may further include determining that the pressure value is below a minimum pressure value. The method 700 may further include responsive to determining the pressure value is below the minimum pressure value, stopping the flow of air to the lamp assembly, as discussed herein with respect to FIGS. 6A and 6B.

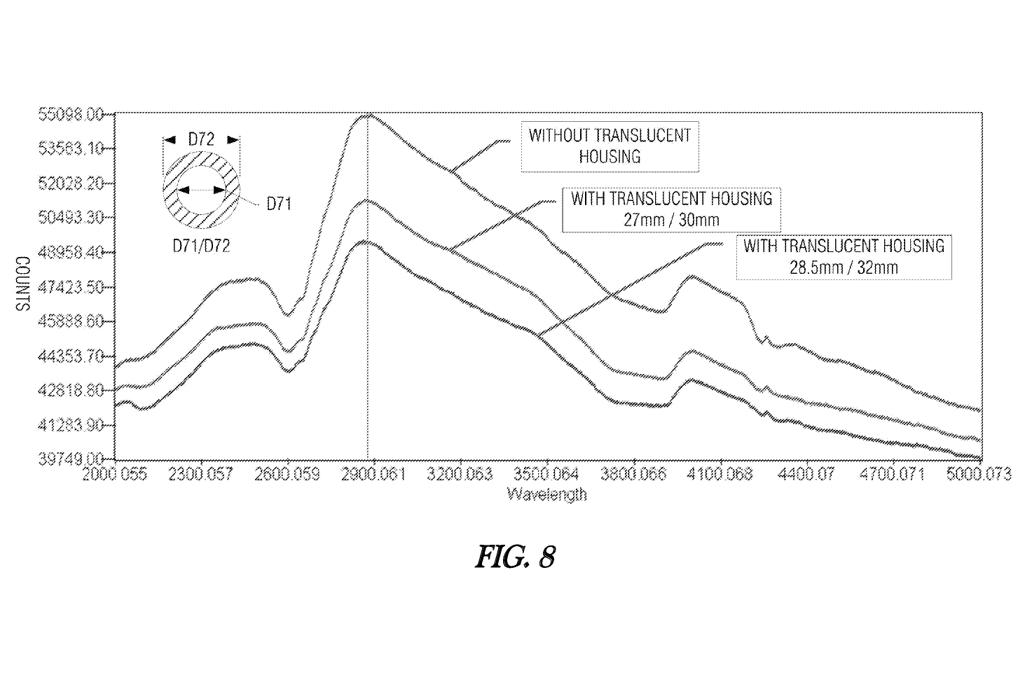

FIG. 8 is a plot showing infrared intensity of example configurations. The curves represent different lamp intensities at different diameter configurations of a translucent housing.

### EXAMPLES

The following example is given to illustrate, but not limit, the scope of this present disclosure.

### Example 1

### Lamp Assembly

Example 1 illustrates dimensions and materials for a lamp assembly. The manifolds of the lamp assembly can be constructed from extruded aluminum. The lamp assembly can include a left manifold, a right manifold, and a distribution manifold positioned between the left manifold and the right manifold and on top of a directing plenum. The left manifold is the manifold that receives an air supply and the right manifold is in fluid communication with the interior of the distribution manifold. The left manifold can have a length of 154 mm, the right manifold can have a length of 110 mm, and the distribution manifold can have a length of 740 mm. The height of the right manifold can be 98 mm.

The directing plenum can have a width of 250 mm. The length between the intersections of the centerlines of the curtain apertures can have a length of 140 mm. Additionally, the length from each of the intersections of the centerlines of the curtain apertures to the edge of the directing plenum can be 55 mm.

The lamp can include a filament disposed in a quartz glass tube (e.g., a filament housing). Additionally, the lamp can be surrounded by a translucent housing formed from quartz adapted to transmit 780 nm. Additionally, a silicon O-ring is used as a seal between the translucent housing and the right manifold.

### Example 2

### Lamp Assembly Operation

Twelve chambers (referred to herein as “Zones”) including a plurality of lamp assemblies of the present disclosure were configured. Each chamber included nine lamp assemblies that were electrically connected in series and used to dry a work product including an anode coating for a battery (hereinafter referred to “anode dryer”). The coating included N-Methy-2-pyrrolidone (NMP). Each chamber included three lamp assemblies having Mid Infrared (“MIR”) Power A lamps and six lamp assemblies having MIR Power B lamps.

Each drying chamber had predetermined settings. Table I is a summary of various predetermined settings for the chambers utilizing the lamps assemblies in Example 2.

TABLE I

| | Zone | Zone | Zone | Zone | Zone | Zone | Zone | Zone | Zone | Zone | Zone | Zone |
|---|---|---|---|---|---|---|---|---|---|---|---|---|
| | 1 | 2 | 3 | 4 | 5 | 6 | 7 | 8 | 9 | 10 | 11 | 12 |
| MIR Power A | 30 | 35 | 40 | 40 | 35 | 30 | 30 | 35 | 40 | 40 | 35 | 30 |
| (%) | | | | | | | | | | | | |
| MIR Power B | 30 | 35 | 40 | 40 | 35 | 30 | 30 | 35 | 40 | 40 | 35 | 30 |
| (%) | | | | | | | | | | | | |
| Exhaust Fan | 70 | 70 | 70 | 70 | 70 | 70 | 70 | 70 | 70 | 70 | 70 | 70 |
| Speed (%) | | | | | | | | | | | | |
| Supply Fan | 70 | 70 | 70 | 70 | 70 | 70 | 70 | 70 | 70 | 70 | 70 | 70 |
| Speed (%) | | | | | | | | | | | | |
| Chamber | 120 | 125 | 125 | 125 | 125 | 120 | 120 | 125 | 125 | 125 | 125 | 120 |
| Temp (° C.) | | | | | | | | | | | | |
| Supply Air | 150 | 150 | 150 | 150 | 150 | 150 | 150 | 150 | 150 | 150 | 150 | 150 |
| Temp (° C.) | | | | | | | | | | | | |

The MIR Power A and the MIR Power B values are given as a percentage of the total power of the lamps. Supply fan speed and the exhaust fan speed are given in a percentage of the total speed. The chamber temperature is the temperature located within the chamber. The supply air temperature is the temperature of the air entering each zone.

The lamp assemblies were allowed to run for 2 hours. After 2 hours, data was gathered. The results are shown in Table II.

TABLE II

| | Zone | Zone | Zone | Zone | Zone | Zone | Zone | Zone | Zone | Zone | Zone | Zone |
|---|---|---|---|---|---|---|---|---|---|---|---|---|
| | 1 | 2 | 3 | 4 | 5 | 6 | 7 | 8 | 9 | 10 | 11 | 12 |
| MIR A | 3.00 | 3.40 | 3.80 | 4.00 | 3.80 | 3.00 | 2.80 | 3.20 | 3.60 | 3.60 | 3.40 | 3.00 |
| power (kw) | | | | | | | | | | | | |
| MIR B | 6.40 | 7.80 | 7.20 | 7.00 | 7.40 | 6.20 | 6.40 | 7.80 | 7.20 | 7.20 | 7.00 | 6.60 |
| power (kw) | | | | | | | | | | | | |
| Steam | 119.00 | 118.00 | 127.00 | 126.00 | 128.00 | 119.00 | 127.00 | 127.00 | 125.00 | 122.00 | 122.00 | 140.00 |
| supply temp | | | | | | | | | | | | |
| (C.) | | | | | | | | | | | | |
| Chamber | 119.00 | 119.00 | 125.00 | 125.00 | 125.00 | 120.00 | 119.00 | 120.00 | 124.00 | 124.00 | 125.00 | 110.00 |
| temperature | | | | | | | | | | | | |
| (C.) | | | | | | | | | | | | |
| Product | 54.00 | 64.00 | 69.00 | 77.00 | 85.00 | 68.00 | 59.00 | 73.00 | 76.00 | 77.00 | 73.00 | 60.00 |
| temperature | | | | | | | | | | | | |
| (C.) | | | | | | | | | | | | |
| NMP gas | 0.00 | 0.00 | 10.00 | 10.00 | 7.00 | 3.00 | 0.00 | 1.00 | 7.00 | 13.00 | 13.00 | 1.00 |
| (%) | | | | | | | | | | | | |
| Module | 15.00 | 14.00 | 14.00 | 14.00 | 14.00 | 14.00 | 14.00 | 14.00 | 15.00 | 14.00 | 15.00 | 15.00 |
| pressure | | | | | | | | | | | | |
| (mbar) | | | | | | | | | | | | |
| Chamber | −16.00 | −22.00 | −19.00 | −18.00 | −18.00 | −23.00 | −19.00 | −13.00 | −18.00 | −17.00 | −14.00 | −17.00 |
| pressure | | | | | | | | | | | | |
| (Pa) | | | | | | | | | | | | |

The MIR A power and the MIR B power are the kilowatts that the MIR A lamp assemblies and the MIR B lamp assemblies are operating. The Steam supply temperature is the temperature of the steam entering each chamber and to the manifold that supplies the air to the lamp assemblies. The product temperature is the temperature of the work piece that is undergoing drying.

The coating on the work product includes NMP, which is flammable. The NMP gas is the percent of NMP that is detected in the exhaust air. The exhaust air is continually tested with a lower explosive limit (LEL) sensor (Gastron, Model 100AD) to determine the amount of NMP is the exhaust air. The gas curtain formed by the lamp assemblies of the present disclosure assist in pulling away NMP vapors from the heated lamps.

The module pressure is the pressure of the air supplies to the plurality of lamp assemblies. The chamber pressure is the pressure of the air supplied to each of the chambers in the zone.

### Various Notes

The above detailed description includes references to the accompanying drawings, which form a part of the detailed description. The drawings show, by way of illustration, specific embodiments in which the invention can be practiced.

In the event of inconsistent usages between this document any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method embodiments described herein can be machine or computer-implemented at least in part. Some embodiments can include a computer-readable medium or machine-readable medium encoded with instructions operable to configure an electronic device to perform methods as described in the above embodiments. An implementation of such methods can include code, such as microcode, assembly language code, a higher-level language code, or the like. Such code can include computer readable instructions for performing various methods. The code may form portions of computer program products. Further, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described embodiments (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

Specific enumerated embodiments [1] to [50] provided below are for illustration purposes only, and do not otherwise limit the scope of the disclosed subject matter, as defined by the claims. These enumerated embodiments encompass all combinations, sub-combinations, and multiply referenced (e.g., multiply dependent) combinations described therein.

### Enumerated Embodiments

[1]. An apparatus for directing a gas over a lamp that is substantially linear and elongate, comprising:
a translucent housing disposed around the lamp defining a space between the lamp and the translucent housing;
a manifold coupled to the translucent housing, the manifold defining a manifold interior configured to be coupled to a pressure source, the manifold interior in fluid communication with the space between the lamp and the translucent housing; and
a seal disposed between the translucent housing and the manifold, the seal configured to resist flow of the gas at a selected pressure

[2]. The apparatus of embodiment [1], comprising a portion of the manifold extending alongside the lamp, the portion of the manifold defining at least one curtain aperture directed at the translucent housing.

[3]. The apparatus of embodiment [2], wherein the portion of the manifold is in fluid communication with another portion of the manifold in fluid communication with the space between the lamp and the translucent housing.

[4]. The apparatus of embodiment [2], wherein the at least one curtain aperture is one of a plurality of curtain apertures periodically spaced along a length of the portion of the manifold and oriented to shape a flow of the gas into a sheet shaped gas curtain to drape away from the lamp.

[5]. The apparatus of embodiment [4], wherein the portion of the manifold includes a flow directing plenum coupled to a base portion, the flow directing plenum defining the plurality of curtain apertures, with a plurality of base portion outlet apertures aligned with, and in fluid communication with, a plurality of flow directing plenum inlet apertures.

[6]. The apparatus of embodiment [5], wherein the flow directing plenum includes a tunnel sized to receive an inlet conduit to extend through the tunnel to couple with the manifold, the tunnel opening to a side of the apparatus through which the lamp is slideably removable.

[7]. The apparatus of embodiment [1], wherein the at least one curtain aperture is one of a plurality of curtain apertures, and wherein the plurality of curtain apertures includes a plurality of columns of curtain apertures aligned along respective axes parallel to the translucent housing.

[8]. The apparatus of embodiment [7], wherein the plurality of columns includes one top column aligned above the lamp, and opposing columns aligned on each side of the translucent housing.

[9]. The apparatus of embodiment [8], wherein at least one curtain aperture of the top column is oriented to direct the gas toward a centerline of the translucent housing, and respective curtain apertures of the opposing columns are oriented to direct the gas below the centerline of the translucent housing.

[10.] The apparatus of embodiment [1], wherein the lamp is slideably removable through an assembly including the translucent housing sealed to the manifold.

[11]. The apparatus of embodiment [1], wherein the translucent housing is formed of transparent glass.

[12]. The apparatus of embodiment [11], wherein the transparent glass is formed of quartz.

[13]. The apparatus of embodiment [1], wherein the translucent housing is free to expand along its length with respect to the manifold.

[14]. A system for directing a gas over a pair of lamps that are substantially linear and elongate, to cool the pair of lamps using a gas, comprising:
respective translucent housings disposed around each lamp defining a space between each lamp and the respective translucent housing, wherein the space around one lamp is in fluid communication with the space around the other lamp;
a manifold coupled to the translucent housing, the manifold defining a manifold interior configured to be coupled to a pressure source, the interior in fluid communication with the space between each lamp and its respective translucent housing, wherein a portion of the manifold extends alongside each lamp, the portion of the manifold defining a plurality of curtain apertures periodically spaced along a length of the portion of the manifold and oriented to shape a flow of the gas into a sheet shaped gas curtain to drape away from each lamp; and
respective seals disposed between the translucent housing and the manifold and configured to resist the flow of the gas at a selected pressure.

[15]. The system of embodiment [14], wherein each lamp is independently slideably removable through an assembly including each translucent housing sealed to the manifold.

[16]. The system of embodiment [14], comprising a portion of the manifold extending alongside each lamp, the portion of the manifold defining a plurality of curtain apertures periodically spaced along a length of the portion of the manifold and oriented to shape a flow of the gas into a sheet shaped gas curtain to drape away from each lamp.

[17]. The system of embodiment [16], wherein the portion of the manifold includes a flow directing plenum coupled to a base portion, the flow directing plenum defining the plurality of curtain apertures, with a plurality of base portion outlet apertures aligned with, and in fluid communication with, a plurality of flow directing plenum inlet apertures, and wherein the flow directing plenum includes a tunnel disposed between the pair of lamps and sized to receive a inlet conduit to extend through the tunnel to couple with the manifold, the tunnel opening to a side of the system through which the lamp is slideably removable.

[18]. A method of cooling a lamp configured to shine on a work piece, comprising:
circulating a gas between a lamp including a filament, the lamp being substantially linear and elongate, and a translucent housing disposed around the lamp defining a space between the lamp and the translucent housing, the gas sealed from an atmosphere proximal the work piece; and
flowing another gas around an exterior of the translucent housing and into a sheet shaped gas curtain draping onto the work piece.

[19]. The method of embodiment [18], comprising providing the gas by taking air from the atmosphere proximal the work piece and drying the taken air.

[20]. The method of embodiment [18], comprising providing the gas by collecting air from a reservoir sealed from the atmosphere proximal the work piece, and discharging the gas to another reservoir.

1. An apparatus for directing a gas over a lamp that is substantially linear and elongate, comprising:
a translucent housing disposed around the lamp defining a space between the lamp and the translucent housing;
a manifold coupled to the translucent housing, the manifold defining a manifold interior configured to be coupled to a pressure source, the manifold interior in fluid communication with the space between the lamp and the translucent housing; and
a seal disposed between the translucent housing and the manifold, the seal configured to resist flow of the gas at a selected pressure.

2. The apparatus of claim 1, comprising a portion of the manifold extending alongside the lamp, the portion of the manifold defining at least one curtain aperture directed at the translucent housing.

3. The apparatus of claim 2, wherein the portion of the manifold is in fluid communication with another portion of the manifold in fluid communication with the space between the lamp and the translucent housing.

4. The apparatus of claim 2, wherein the at least one curtain aperture is one of a plurality of curtain apertures periodically spaced along a length of the portion of the manifold and oriented to shape a flow of the gas into a sheet shaped gas curtain to drape away from the lamp.

5. The apparatus of claim 4, wherein the portion of the manifold includes a flow directing plenum coupled to a base portion, the flow directing plenum defining the plurality of curtain apertures, with a plurality of base portion outlet apertures aligned with, and in fluid communication with, a plurality of flow directing plenum inlet apertures.

6. The apparatus of claim 5, wherein the flow directing plenum includes a tunnel sized to receive an inlet conduit to extend through the tunnel to couple with the manifold, the tunnel opening to a side of the apparatus through which the lamp is slideably removable.

7. (canceled)

8. (canceled)

9. (canceled)

10. The apparatus of claim 1, wherein the lamp is slideably removable through an assembly including the translucent housing sealed to the manifold.

11. The apparatus of claim 1, wherein the translucent housing is formed of transparent glass.

12. The apparatus of claim 11, wherein the transparent glass is formed of quartz.

13. The apparatus of claim 1, wherein the translucent housing is free to expand along its length with respect to the manifold.

14. A system for directing a gas over a pair of lamps that are substantially linear and elongate, to cool the pair of lamps using a gas, comprising:
respective translucent housings disposed around each lamp defining a space between each lamp and the respective translucent housing, wherein the space around one lamp is in fluid communication with the space around the other lamp;
a manifold coupled to the translucent housing, the manifold defining a manifold interior configured to be coupled to a pressure source, the interior in fluid communication with the space between each lamp and its respective translucent housing, wherein a portion of the manifold extends alongside each lamp, the portion of the manifold defining a plurality of curtain apertures periodically spaced along a length of the portion of the manifold and oriented to shape a flow of the gas into a sheet shaped gas curtain to drape away from each lamp; and
respective seals disposed between the translucent housing and the manifold and configured to resist the flow of the gas at a selected pressure.

15. The system of claim 14, wherein each lamp is independently slideably removable through an assembly including each translucent housing sealed to the manifold.

16. The system of claim 14, comprising a portion of the manifold extending alongside each lamp, the portion of the manifold defining a plurality of curtain apertures periodically spaced along a length of the portion of the manifold and oriented to shape a flow of the gas into a sheet shaped gas curtain to drape away from each lamp.

17. The system of claim 16, wherein the portion of the manifold includes a flow directing plenum coupled to a base portion, the flow directing plenum defining the plurality of curtain apertures, with a plurality of base portion outlet apertures aligned with, and in fluid communication with, a plurality of flow directing plenum inlet apertures, and wherein the flow directing plenum includes a tunnel disposed between the pair of lamps and sized to receive a inlet conduit to extend through the tunnel to couple with the manifold, the tunnel opening to a side of the system through which the lamp is slideably removable.

18. A method of cooling a lamp configured to shine on a work piece, comprising:
circulating a gas between a lamp including a filament, the lamp being substantially linear and elongate, and a translucent housing disposed around the lamp defining a space between the lamp and the translucent housing, the gas sealed from an atmosphere proximal the work piece; and
flowing another gas around an exterior of the translucent housing and into a sheet shaped gas curtain draping onto the work piece.

19. The method of claim 18, comprising providing the gas by taking air from the atmosphere proximal the work piece and drying the taken air.

20. The method of claim 18, comprising providing the gas by collecting air from a reservoir sealed from the atmosphere proximal the work piece, and discharging the gas to another reservoir.
